(19) United States
(12) Patent Application Publication
(10) Pub. No.: US 2011/0054069 A1
(43) Pub. Date: Mar. 3, 2011

(54) RUBBER COMPOSITION HAVING IMPROVED CRACK RESISTANCE

(75) Inventor: Zhong-Ren Chen, Stow, OH (US)

(73) Assignee: Bridgestone Corporation, Tokyo (JP)

(21) Appl. No.: 12/870,260

(22) Filed: Aug. 27, 2010

Related U.S. Application Data
(60) Provisional application No. 61/237,810, filed on Aug. 28, 2009.

(51) Int. Cl. C08J 5/14

(52) U.S. Cl. 523/150

(57) ABSTRACT

Disclosed is a rubber composition which comprises: (a) a first polymer, (b) a second polymer that is different from said first polymer, (c) a filler, (d) a first low molecular weight polymer comprising a block A and a block B, wherein said block A comprises a majority of the same type of mer units that make up a majority of the first polymer and block B comprises a majority of the same type of mer units that make up a majority of the second polymer, and (e) a second low molecular weight polymer comprising at least one functional group, wherein said first and second low molecular weight polymers have number average molecular weights of about 5,000 to about 100,000. Also disclosed is a method of mixing the rubber composition.

This application claims the benefit of U.S. Provisional Application No. 61/237,810, filed Aug. 28, 2009, which is incorporated herein by reference in its entirety.

### FIELD OF THE DISCLOSURE

This disclosure generally relates to rubber compositions comprising a combination of at least two low molecular weight polymers.

### BACKGROUND

Most rubber compositions, especially rubber compositions suitable for tires or air springs, contain multiple polymers and may also contain multiple fillers. However, different types of fillers have different affinities towards different types of polymers. For example, in a rubber composition containing polybutadiene and natural rubber, carbon black is likely to be more concentrated in the polybutadiene phase since carbon black has a higher affinity towards polybutadiene versus natural rubber. This type of filler distribution may impact crack growth resistance in rubber compositions such as tire sidewalls or air springs. Moreover, the domain size of the different types of polymers may impact the crack growth of the rubber composition.

Thus, what is needed is a rubber composition that has a more even distribution of filler among the different polymers, as well as a rubber composition that has smaller domain sizes of the different types of polymers.

### SUMMARY

Disclosed is a rubber composition which comprises: (a) a first polymer, (b) a second polymer that is different from said first polymer, (c) a filler, (d) a first low molecular weight polymer comprising a block A and a block B, wherein said block A comprises a majority of the same type of mer units that make up a majority of the first polymer and block B comprises a majority of the same type of mer units that make up a majority of the second polymer, and (e) a second low molecular weight polymer comprising at least one functional group, wherein said first and second low molecular weight polymers have number average molecular weights of about 5,000 to about 100,000.

Also disclosed is a rubber composition which comprises: (a) a first polymer comprising isoprene mer units, (b) a second polymer that is different from said first polymer, (c) a filler, (d) a first low molecular weight polymer comprising a block A and a block B, wherein said block A comprises isoprene mer units and block B comprises a majority of the same type of mer units that make up a majority of the second polymer, and (e) a second low molecular weight polymer comprising isoprene mer units and at least one functional group, wherein said first and second low molecular weight polymers have number average molecular weights of about 5,000 to about 100,000.

Also disclosed is a method comprising:
a. mixing in a first step:
   i. a first polymer,
   ii. a filler,
   iii. a first low molecular weight polymer comprising a block A and a block B, and
   iv. a second low molecular weight polymer comprising one or more functional groups,
b. mixing in a second step:
   i. the mixture obtained in step (a),
   ii. a second polymer different from said first polymer, and
   iii. optionally, additional filler,
      wherein said block A comprises a majority of the same type of mer units that make up a majority of said first polymer and said block B comprises a majority of the same type of mer units that make up a majority of said second polymer, and wherein said first and second low molecular weight polymers have number average molecular weights of about 5,000 to about 100,000.

Also disclosed is a method comprising:
a. mixing in a first step:
   i. a first polymer comprising isoprene mer units,
   ii. a filler,
   iii. a first low molecular weight polymer comprising a block A and a block B, and
   iv. a second low molecular weight polymer comprising isoprene mer units and one or more functional groups,
b. mixing in a second step:
   i. the mixture obtained in step (a),
   ii. a second polymer different from said first polymer, and
   iii. optionally, additional filler,
      wherein said block A comprises isoprene mer units and said block B comprises a majority of the same type of mer units that make up a majority of said second polymer, and wherein said first and second low molecular weight polymers have number average molecular weights of about 5,000 to about 100,000.

Other aspects of the present disclosure will be apparent to the ordinarily skilled artisan from the description that follows. To assist in understanding the description of various embodiments that follow, certain definitions are provided immediately below. These are intended to apply throughout unless the surrounding text explicitly indicates a contrary intention:

“polymer” means the polymerization product of one or more monomers and is inclusive of homo-, co-, ter-, tetra-polymers, etc.;

“mer” or “mer unit” means that portion of a polymer derived from a single reactant molecule (e.g., ethylene mer has the general formula —CH2CH2-);

“copolymer” means a polymer that includes mer units derived from two reactants, typically monomers, and is inclusive of random, block, segmented, graft, gradient, etc., copolymers; and

“phr” means parts by weight of a referenced material per 100 parts by weight rubber, and is a recognized term by those having skill in the rubber compounding art.

All references incorporated herein by reference are incorporated in their entirety unless otherwise stated.

All number average molecular weights reported herein are calculated by using gel permeation chromatography (GPC) calibrated with polystyrene standards.

### DETAILED DESCRIPTION

A rubber composition according to the disclosure comprises: (a) a first polymer, (b) a second polymer that is different from said first polymer, (c) a filler, (d) a first low molecular weight polymer comprising a block A and a block B, wherein said block A comprises a majority of the same type of mer units that make up a majority of the first polymer and block B comprises a majority of the same type of mer units that make up a majority of the second polymer, and (e) a second low molecular weight polymer comprising at least one functional group, wherein said first and second low molecular weight polymers have number average molecular weights of about 5,000 to about 100,000.

The first polymer may be any polymer. Suitable polymers that may be used as the first polymer include, but are not limited to, polyisoprene (synthetic polyisoprene or natural rubber), styrene-butadiene rubber (SBR), styrene-isoprene rubber, styrene-isoprene-butadiene rubber, isoprene-butadiene rubber, polybutadiene (BR), acrylonitrile-butadiene rubber (NBR), silicone rubber, fluoroelastomers, ethylene acrylic rubber, nitrile rubber, hydrogenated nitrile rubber, ethylene propylene rubber (EPR), ethylene propylene diene monomer (EPDM) rubber, butyl rubber, polychloroprene, and mixtures thereof. In one embodiment, the first polymer comprises isoprene mer units. If the first polymer is one that contains isoprene mer units, it may be any polymer comprising isoprene mer units. Suitable polymers containing isoprene mer units may include, but are not limited to, those selected from the group consisting of polyisoprene (natural rubber or synthetic polyisoprene), isoprene-butadiene copolymer, isobutylene-isoprene copolymer, styrene-isoprene rubber, and mixtures thereof. In one embodiment, the first polymer is polyisoprene.

The first polymer may have a number average molecular weight of between about 100,000 to about 500,000, or between about 125,000 to about 400,000, or between about 150,000 to about 300,000.

The first polymer may be added to the rubber composition in an amount ranging from about 1 phr to about 99 phr, or from about 10 phr to about 80 phr, or from about 20 phr to about 60 phr, or from about 30 phr to about 50 phr.

The second polymer that is different from the first polymer may be any polymer. By stating that the second polymer is different from the first polymer, it is meant that the second polymer contains at least one mer unit that is different from the mer unit(s) in the first polymer, and optionally additional mer units that are the same as those in the first polymer. For example, if the first polymer is polyisoprene, the second polymer may be isoprene-butadiene copolymer. Suitable polymers that may be used as the second polymer include, but are not limited to, styrene-butadiene rubber (SBR), styrene-isoprene rubber, styrene-isoprene-butadiene rubber, isoprene-butadiene rubber, polybutadiene (BR), acrylonitrile-butadiene rubber (NBR), silicone rubber, fluoroelastomers, ethylene acrylic rubber, nitrile rubber, hydrogenated nitrile rubber, ethylene propylene rubber (EPR), ethylene propylene diene monomer (EPDM) rubber, butyl rubber, polychloroprene, and mixtures thereof. In one embodiment, the second polymer is polybutadiene.

The second polymer may have a number average molecular weight of between about 100,000 to about 500,000, or between about 125,000 to about 400,000, or between about 150,000 to about 300,000.

The second polymer may be added to the rubber composition in an amount ranging from about 1 phr to about 99 phr, or from about 20 phr to about 80 phr, or from about 40 phr to about 80 phr, or from about 50 phr to about 70 phr.

The rubber composition contains a filler. The filler may be selected from the group consisting of carbon black, silica, and mixtures thereof. The total amount of filler may be from about 1 to about 200 phr, or alternatively from about 5 to about 100 phr, or alternatively from about 30 to about 80 phr, or from about 40 to about 70 phr.

Carbon black may be present in an amount of about 1 to about 200 phr, or alternatively in an amount of about 5 to about 100 phr, or alternatively in an amount of about 30 to about 80 phr. Suitable carbon blacks include commonly available, commercially-produced carbon blacks, but those having a surface area of at least 20 m²/g, or preferably, at least 35 m²/g up to 200 m²/g or higher are preferred. Among useful carbon blacks are furnace black, channel blacks, and lamp blacks. A mixture of two or more of the above blacks can be used. Exemplary carbon blacks include, but are not limited to, N-110, N-220, N-339, N-330, N-352, N-550, N-660, as designated by ASTM D-1765-82a.

Examples of reinforcing silica fillers which can be used include wet silica (hydrated silicic acid), dry silica (anhydrous silicic acid), calcium silicate, and the like. Among these, precipitated amorphous wet-process, hydrated silicas are preferred. Silica can be employed in an amount of about 1 to about 100 phr, or alternatively in an amount of about 5 to about 80 phr, or alternatively in an amount of about 30 to about 80 phr. The useful upper range is limited by the high viscosity imparted by fillers of this type. Some of the commercially available silicas which can be used include, but are not limited to, HiSil® 190, HiSil® 210, HiSil® 215, HiSil® 233, HiSil® 243, and the like, produced by PPG Industries (Pittsburgh, Pa.). A number of useful commercial grades of different silicas are also available from DeGussa Corporation (e.g., VN2, VN3), Rhone Poulenc (e.g., Zeosil® 1165MP0), and J. M. Huber Corporation.

The surface of the carbon black and/or silica may also be treated or modified to improve the affinity to particular types of polymers. Such surface treatments and modifications are well known to those skilled in the art.

If silica is used as a filler, it may be desirable to use a coupling agent to couple the silica to the polymer. Numerous coupling agents are known, including but not limited to organosulfide polysulfides and organoalkoxymercaptosilanes. Any organosilane polysulfide may be used. Suitable organosilane polysulfides include, but are not limited to, 3,3′-bis(trimethoxysilylpropyl)disulfide, 3,3′-bis(triethoxysilylpropyl)disulfide, 3,3′-bis(triethoxysilylpropyl)tetrasulfide, 3,3′-bis(triethoxysilylpropyl)octasulfide, 3,3′-bis(trimethoxysilylpropyl)tetrasulfide, 2,2′-bis(triethoxysilylethyl)tetrasulfide, 3,3′-bis(trimethoxysilylpropyl)trisulfide, 3,3′-bis(triethoxysilylpropyl)trisulfide, 3,3′-bis(tributoxysilylpropyl)disulfide, 3,3′-bis(trimethoxysilylpropyl)hexasulfide, 3,3′-bis(trimethoxysilylpropyl)octasulfide, 3,3′-bis(trioctoxysilylpropyl)tetrasulfide, 3,3′-bis(trihexoxysilylpropyl)disulfide, 3,3′-bis(tri-2″-ethylhexoxysilylpropyl)trisulfide, 3,3′-bis(triisooctoxysilylpropyl)tetrasulfide, 3,3′-bis(tri-t-butoxysilylpropyl)disulfide, 2,2′-bis(methoxydiethoxysilylethyl)tetrasulfide, 2,2′-bis(tripropoxysilylethyl)pentasulfide, 3,3′-bis(tricycloneoxysilylpropyl)tetrasulfide, 3,3′-bis(tricyclopentoxysilylpropyl)trisulfide, 2,2′-bis(tri-2″-methylcyclohexoxysilylethyl)tetrasulfide, bis(trimethoxysilylmethyl)tetrasulfide, 3-methoxyethoxypropoxysilyl 3′-diethoxybutoxy-silylpropyl tetrasulfide, 2,2′-bis(dimethylmethoxysilylethyl)disulfide, 2,2′-bis(dimethylsecbutoxysilylethyl)trisulfide, 3,3′-bis(methylbutylethoxysilylpropyl)tetrasulfide, 3,3′-bis(di t-butylmethoxysilylpropyl) tetrasulfide, 2,2′-bis(phenylmethylmethoxysilylethyl)trisulfide, 3,3′-bis(diphenyl isopropoxysilylpropyl)tetrasulfide, 3,3′-bis(diphenylcyclohexoxysilylpropyl)disulfide, 3,3′-bis(dimethylethylmercaptosilylpropyl)tetrasulfide, 2,2′-bis(methyldimethoxysilylethyl)trisulfide, 2,2′-bis(methyl ethoxypropoxysilylethyl)tetrasulfide, 3,3′-bis(diethylmethoxysilylpropyl)tetrasulfide, 3,3′-bis(ethyldi-secbutoxysilylpropyl)disulfide, 3,3′-bis(propyldiethoxysilylpropyl)disulfide, 3,3′-bis(butyldimethoxysilylpropyl)trisulfide, 3,3′-bis(phenyldimethoxysilylpropyl)tetrasulfide, 3′-trimethoxysilylpropyl tetrasulfide, 4,4′-bis(trimethoxysilylbutyl)tetrasulfide, 6,6′-bis(triethoxysilylhexyl)tetrasulfide, 12,12′-bis(triisopropoxysilyldodecyl)disulfide, 18,18′-bis(trimethoxysilyloctadecyl)tetrasulfide, 18,18′-bis(tripropoxysilyloctadecenyl)tetrasulfide, 4,4′-bis(trimethoxysilyl-buten-2-yl)tetrasulfide, 4,4′-bis(trimethoxysilylcyclohexylene)tetrasulfide, 5,5′-bis(dimethoxymethylsilylpentyl)trisulfide, 3,3′-bis(trimethoxysilyl-2-methylpropyl)tetrasulfide and 3,3′-bis(dimethoxyphenylsilyl-2-methylpropyl)disulfide.

Suitable organoalkoxymercaptosilanes include, but are not limited to, triethoxy mercaptopropyl silane, trimethoxy mercaptopropyl silane, methyl dimethoxy mercaptopropyl silane, methyl diethoxy mercaptopropyl silane, dimethyl methoxy mercaptopropyl silane, triethoxy mercaptoethyl silane, tripropoxy mercaptopropyl silane, ethoxy dimethoxy mercaptopropylsilane, ethoxy diisopropoxy mercaptopropylsilane, ethoxy didodecyloxy mercaptopropylsilane and ethoxy dihexadecyloxy mercaptopropylsilane. Such organoalkoxymercaptosilanes may be capped with a blocking group, i.e., the mercapto hydrogen atom is replaced with another group. A representative example of a capped organoalkoxymercaptosilane coupling agent is a liquid 3-octanoylthio-1-propyltriethoxysilane, available as NXT™ Silane from Momentive Performance Materials Inc.

Mixtures of various organosilane polysulfide compounds and organoalkoxymercaptosilanes can be used.

The amount of coupling agent in the composition is the amount needed to produce acceptable results, which is easily determined by one skilled in the art. The amount of coupling agent is typically based on the weight of the silica in the composition, and may be from about 0.1% to about 20% by weight of silica, or alternatively from about 1% to about 15% by weight of silica, or alternatively from about 1% to about 10% by weight of silica.

Additional fillers may also be utilized, including but not limited to, mineral fillers, such as clay, talc, aluminum hydrate, aluminum hydroxide and mica. The foregoing additional fillers are optional and can be utilized in varying amounts from about 0.5 phr to about 40 phr.

The rubber composition comprises a first low molecular weight polymer comprising a block A and a block B, where block A comprises a majority of the same type of mer units that make up a majority of the first polymer and block B comprises a majority of the same type of mer units that make up a majority of the second polymer. In one embodiment, Block A comprises from about 70 mol % to about 100 mol % of the same type of mer units that make up a majority of the first polymer. In another embodiment, Block A comprises from about 90 mol % to about 100 mol % of the same type of mer units that make up a majority of the first polymer. For example, if the first polymer in the rubber composition is polyisoprene, Block A should comprise a majority of isoprene mer units, or from about 70 mol % to about 100 mol % of isoprene mer units, or from about 90 mol % to about 100 mol % of isoprene mer units.

If the first polymer in the rubber composition comprises more than one type of mer unit, Block A should comprise a majority of the same type of the mer units that makes up the largest portion of the first polymer. For example, if the first polymer in the rubber composition is an isoprene-butadiene rubber having 80 mol % isoprene and 20 mol % butadiene, Block A should comprise a majority of isoprene since isoprene makes up the majority of the first polymer.

In one embodiment, Block A may comprise isoprene mer units. In another embodiment, Block A comprises a majority of isoprene mer units. In yet another embodiment, Block A comprises from about 70 to about 100 mol % of isoprene mer units. In yet another embodiment, Block A comprises from about 95 to about 100 mol % of isoprene mer units.

The number average molecular weight of Block A may be from about 1,000 to about 100,000, or from about 2,000 to about 50,000, or from about 3,000 to about 30,000.

Block B of the first low molecular weight polymer comprises a majority of the same type of mer units that make up a majority of the second polymer. In one embodiment, Block B comprises from about 70 mol % to about 100 mol % of the same type of mer units that make up a majority of the second polymer. In another embodiment, Block B comprises from about 90 mol % to about 100 mol % of the same type of mer units that make up a majority of the second polymer. For example, if the second polymer in the rubber composition is polybutadiene, Block B should comprise a majority of butadiene mer units, or from about 70 mol % to about 100 mol % of butadiene mer units, or from about 90 mol % to about 100 mol % of butadiene mer units.

If the second polymer in the rubber composition comprises more than one type of mer unit, Block B should comprise a majority of the same type of the mer unit that makes up the largest portion of the second polymer. For example, if the second polymer in the rubber composition is a styrene-butadiene rubber having 23.5 mol % styrene and 76.5 mol % butadiene, Block B should comprise a majority of butadiene since butadiene makes up the majority of the second polymer.

The number average molecular weight of Block B may be from about 1,000 to about 100,000, or from about 2,000 to about 50,000, or from about 3,000 to about 30,000.

The number average molecular weight of the first low molecular weight polymer may be from about 5,000 to about 100,000, or from about 10,000 to about 70,000, or from about 20,000 to about 60,000.

Block A may make up from about 1 to about 99 mol % of the first low molecular weight polymer, or less than about 50 mol %, or less than about 25 mol %.

Exemplary commercially available polymers suitable as the first low molecular weight polymer include, but are not limited to, LIR-390, a block copolymer of isoprene and butadiene, and LIR-310, a block copolymer of isoprene and styrene, both of which are available from Kuraray Co.

The first low molecular weight polymer may be added to the rubber composition in any amount, but preferably is added in an amount of about 1 phr to about 30 phr, or from about 1 phr to about 20 phr, or from about 1 phr to about 10 phr.

The second low molecular weight polymer in the rubber composition comprises at least one functional group. The second low molecular weight polymer may contain any type of mer unit, including, but not limited to, butadiene, isoprene, styrene, isobutylene, and mixtures thereof. In one embodiment, the second low molecular weight polymer contains isoprene mer units. The second low molecular weight polymer may comprise any amount of isoprene mer units. In one embodiment, the second low molecular weight polymer comprises a majority of isoprene mer units. In another embodiment, the second low molecular weight polymer comprises from about 70 to about 100 mol % of isoprene mer units. In yet another embodiment, the second low molecular weight polymer comprises from about 95 to about 100 mol % of isoprene mer units. In one embodiment, the second low molecular weight polymer is polyisoprene.

The functional group(s) on the second low molecular weight polymer may be any functional group that interacts with the filler(s) in the rubber composition. Suitable functional groups include, but are not limited to, those selected from the group consisting of hydroxyl, carboxyl, carbonyl, alkoxy, alkoxycarbonyl, cyano, amino, amido, imido, mercapto, carbamoyl, azido, ester, ether, urethane, peroxide, imidazolyl, and pyridine groups, as well as derivatives of those groups, and mixtures thereof. In one embodiment, the functional group(s) is carboxyl.

Optionally, if the second low molecular weight polymer contains carbonyl groups, such as, for example, from the presence of succinic anhydride, a protic material such as water, methanol, or ethanol, may be added to the rubber composition to produce carboxyl group(s) on the second low molecular weight polymer. This, however, is optional, as it may be desirable for the second low molecular weight polymer to contain carbonyl groups.

The number average molecular weight of the second low molecular weight polymer may be from about 5,000 to about 100,000, or from about 10,000 to about 70,000, or from about 20,000 to about 60,000.

Exemplary commercially available polymers suitable as the second low molecular weight polymer include, but are not limited to, LIR-403 and LIR-410, which are available from Kuraray Co.

The second low molecular weight polymer may be added to the rubber composition in any amount, but preferably is added in an amount of about 1 phr to about 30 phr, or from about 1 phr to about 20 phr, or from about 1 phr to about 10 phr

Other ingredients that may be employed in the rubber composition include oils, waxes, scorch inhibiting agents, tackifying resins, reinforcing resins, fatty acids such as stearic acid, peptizers, vulcanization agents and vulcanization accelerators. These ingredients are known in the art, and may be added in appropriate amounts based on the desired physical and mechanical properties of the rubber composition. Also, other polymers, in addition to the first polymer and second polymer mentioned above, may be added to the composition such that the rubber composition contains at least three different polymers.

The rubber composition can be prepared by mixing the ingredients of the composition together by methods known in the art, such as, for example, by kneading the ingredients together in a Banbury mixer. By way of example, all of the ingredients other than the vulcanization agents and vulcanization accelerators may be mixed in at least one non-productive mixing step. Subsequently, in a productive mixing step, the vulcanization agents and vulcanization accelerators may then be mixed with the mixture obtained in the non-productive mixing step(s). However, these mixing methods are only exemplary and other contemplated methods my be used to prepare the rubber composition.

In one embodiment, the rubber composition may be prepared by mixing in a first step the first polymer, a filler, the first low molecular weight polymer containing block A and block B, and the second low molecular weight polymer. In a second mixing step, the mixture obtained from the first step is mixed with the second polymer that is different from the first polymer, and, optionally, a filler. If a filler is added in the second stage, it may be the same as or different from the filler utilized in the first mixing step. Subsequently, the vulcanization agents and vulcanization accelerators may then be mixed with the mixture obtained in the second step.

The mixing steps where ingredients other than vulcanization agents and vulcanization accelerators are mixed, i.e., non-productive mixing steps, may be conducted at a temperature of about 130° C. to about 200° C. If more than one of these mixing steps are used, the temperatures achieved can be the same or different from each other.

The method can further include a remill step between the non-productive and productive mixing steps, in which no ingredients are added. The remill step may reduce the compound viscosity and improve the dispersion of the filler. The drop temperature of the remill step is typically from about 130° C. to about 175° C., especially from about 145° C. to about 165° C.

The mixing step where vulcanization agents and vulcanization accelerators are added, i.e., the productive mixing step, is conducted at a temperature below the vulcanization temperature in order to avoid unwanted precure of the rubber composition. Therefore, the temperature of the productive mixing step should not exceed about 120° C. and is typically about 40° C. to about 120° C., suitably about 60° C. to about 110° C. and, especially, about 75° C. to about 100° C.

The rubber composition of the disclosure is particularly useful as a tire component or an air spring component, although other rubber articles may also be formed. Exemplary tire components include, but are not limited to, tread and sidewall. There are many benefits of the disclosed rubber composition, including improved crack growth resistance.

The present disclosure will be described in more detail with reference to the following examples. The following examples are presented for purposes of illustration only and are not to be construed in a limiting sense.

### EXAMPLES

Four rubber compositions were prepared according to the formulations shown in Table 1. Table 1 also identifies the mixing step where each ingredient was added. The compositions were prepared by mixing the ingredients together in a Banbury mixer. As can be seen in Table 1, Composition 1 contains no low molecular weight polymer. Composition 2 contains only one low molecular weight polymer, which is a functional polyisoprene polymer suitable as the second low molecular weight polymer of the disclosure. Composition 3 also contains only one low molecular weight polymer; however, the low molecular weight polymer in Composition 3 is a block copolymer polymer suitable as the first low molecular weight polymer of the disclosure. Composition 4 contains a combination of the low molecular weight polymers used in Compositions 2 and 3. All amounts shown are in phr.

TABLE 1

| | Composition | Composition | Composition | Composition |
|---|---|---|---|---|
| | 1 | 2 | 3 | 4 |
| Mixing Step 1 | | | | |
| Natural Rubber | 35 | 33.65 | 33.65 | 33.65 |
| Carbon Black | 20 | 19.23 | 19.23 | 19.23 |
| Aromatic Oil | 4 | 0 | 0 | 0 |
| LIR-410¹ | 0 | 4.81 | 0 | 4.81 |
| LIR-390² | 0 | 0 | 4.81 | 4.81 |
| ZnO | 3 | 2.88 | 2.88 | 2.88 |
| Stearic acid | 2 | 1.92 | 1.92 | 1.92 |
| Antioxidants | 4.5 | 4.33 | 4.33 | 4.33 |
| Waxes | 1.7 | 1.63 | 1.63 | 1.63 |
| Resin | 2 | 1.92 | 1.92 | 1.92 |
| Mixing Step 2 | | | | |
| Composition from Mixing Step 1 | 72.2 | 71.35 | 71.35 | 73.27 |
| BR | 65 | 61.54 | 61.54 | 56.73 |
| CB | 30 | 28.85 | 28.85 | 28.85 |
| Mixing Step 3 | | | | |
| Composition from Mixing Step 2 | 167.2 | 160.77 | 160.77 | 160.77 |
| Sulfur | 1.4 | 1.35 | 1.35 | 1.35 |
| Accelerators | 0.55 | 0.53 | 0.53 | 0.53 |

¹LIR-410 is available from Kuraray Co, and is a polyisoprene polymer having a number average molecular weight of about 25,000, a glass transition temperature of −59° C., and the formula 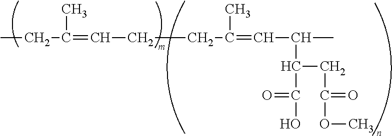
and has approximately 10 functionality groups in one molecule.
²LIR-390 is available from Kuraray Co, and is a block copolymer of isoprene and butadiene, having a number average molecular weight of about 48,000, a glass transition temperature of −95° C., and contains about 90 mol % butadiene and 10 mol % isoprene.

The low molecular weight polymers were added in place of a portion of polyisoprene and polybutadiene. The aromatic oil was also eliminated in order to obtain rubber compositions having similar modulus at 100% elongation.

Properties of the rubber compositions are shown in Table 2. Mooney viscosity of the rubber compositions was determined in accordance with ASTM D-1646 at 130° C.

To conduct durometer, tensile and crack growth testing, the rubber compositions were vulcanized for 15 minutes at 171° C. Tensile mechanical properties were measured by using the procedure described in ASTM-D 412 at 72° F. The tensile test specimens had dumbbell shapes with a thickness of 1.9 mm. A specific gauge length of 25.4 mm was used for the tensile test.

Crack growth testing was done by Dc/Dn. Dc/Dn testing was done on a specimen having the specifications according to Die C of ASTM-D 412. The sample is pre-cut 0.5 mm in the center of the sample in the direction perpendicular to the strain. The initial gauge length of the specimen is 25 mm. Cyclic deformation is applied along the length direction with a strain amplitude of either 60%, 75%, 95% and 115%. The frequency is 240 cycles per minute. The Dc/Dn testing was conducted at room temperature. The number of cycles necessary to cause the sample to break are recorded, with a higher number of cycles indicating a better crack growth resistance.

TABLE 2

| | Composition | Composition | Composition | Composition |
|---|---|---|---|---|
| | 1 | 2 | 3 | 4 |
| Mooney Viscosity | 41.6 | 46.8 | 41.6 | 40.2 |
| DUROMETER, 72^{°} F. (Shore | 50.9 | 51 | 50 | 49.6 |
| A) | | | | |
| Modulus @ 100% | 1.4 | 1.3 | 1.3 | 1.3 |
| elongation, 72^{°} F. (Mpa) | | | | |
| Modulus @ 300% | 6.1 | 5.1 | 6.3 | 5.1 |
| elongation, 72^{°} F. (Mpa) | | | | |
| Tensile at Break, 72^{°} F. | 16.8 | 10.4 | 16.0 | 11.5 |
| (Mpa) | | | | |
| Elongation at Break, 72^{°} F. (%) | 650 | 556 | 628 | 566 |
| Dc/Dn | cycles | cycles | cycles | cycles |
| 60% strain | 1.0E+06 | 9.0E+05 | 7.8E+05 | 1.3E+06 |
| 75% strain | 3.1E+05 | 6.2E+05 | 3.3E+05 | 4.8E+05 |
| 95% strain | 2.4E+05 | 1.9E+05 | 5.1E+04 | 3.4E+05 |
| 115% strain | 7.0E+04 | 9.7E+04 | 4.0E+04 | 1.9E+05 |

As can be seen in Table 2, the compositions have approximately the same modulus at 100% elongation. Thus, the compositions have approximately the same modulus for the Dc/Dn test since the testing is conducted at a maximum of 115% strain. On average, the use of only one low molecular weight polymer improves the crack resistance as evidenced by the increased cycles to break in the Dc/Dn test. However, unexpectedly, the use of both a first low molecular weight polymer and a second low molecular weight polymer according to the disclosure, as in Composition 4, on average further improves the crack resistance properties of the rubber composition. Of particular interest for tire sidewall applications is the improvement seen at 60% strain, since tire sidewalls typically have strain levels of less than 60%. Therefore, Composition 4 is expected to have better crack resistance performance as a tire sidewall than the other Compositions.

The description has been provided with exemplary embodiments. Obviously, modifications and alterations will occur to others upon reading and understanding the preceding detailed description. It is intended that the exemplary embodiments be construed as including all such modifications and alterations insofar as they come within the scope of the appended claims or the equivalents thereof.

We claim:

1. A rubber composition comprising:
a. a first polymer,
b. a second polymer that is different from said first polymer,
c. a filler,
d. a first low molecular weight polymer comprising a block A and a block B, wherein said block A comprises a majority of the same type of mer units that make up a majority of said first polymer and block B comprises a majority of the same type of mer units that make up a majority of said second polymer, and
e. a second low molecular weight polymer comprising at least one functional group,
wherein said first and second low molecular weight polymers have number average molecular weights of about 5,000 to about 100,000.

2. The rubber composition of claim 1, wherein said first polymer is polyisoprene.

3. The rubber composition of claim 1, wherein said second polymer is selected from the group consisting of styrene-butadiene rubber, styrene-isoprene rubber, styrene-isoprene-butadiene rubber, isoprene-butadiene rubber, polybutadiene, acrylonitrile-butadiene rubber, silicone rubber, fluoroelastomers, ethylene acrylic rubber, nitrile rubber, hydrogenated nitrile rubber, ethylene propylene rubber, ethylene propylene diene monomer rubber, butyl rubber, polychloroprene, and mixtures thereof.

4. The rubber composition of claim 1, wherein said second polymer is polybutadiene.

5. The rubber composition of claim 1, wherein said filler comprises carbon black.

6. The rubber composition of claim 4, wherein block A of said first low molecular weight polymer comprises polyisoprene and block B comprises polybutadiene.

7. The rubber composition of claim 1, wherein said second low molecular weight polymer is polyisoprene.

8. The rubber composition of claim 7, wherein said functional group(s) is selected from the group consisting of hydroxyl, carboxyl, carbonyl, alkoxy, alkoxycarbonyl, cyano, amino, amido, imido, mercapto, carbamoyl, azido, ester, ether, urethane, peroxide, imidazolyl, and pyridine groups, as well as derivatives of those groups, and mixtures thereof.

9. The rubber composition of claim 7, wherein said functional group(s) comprises carboxyl.

10. A tire comprising the rubber composition of claim 1.

11. A tire comprising a sidewall, wherein said sidewall comprises the rubber composition of claim 1.

12. A rubber composition comprising:
a. a first polymer comprising isoprene mer units,
b. a second polymer that is different from said first polymer,
c. a filler,
d. a first low molecular weight polymer comprising a block A and a block B, wherein said block A comprises isoprene mer units and block B comprises a majority of the same type of mer units that make up a majority of said second polymer, and
e. a second low molecular weight polymer comprising isoprene mer units and at least one functional group,
wherein said first and second low molecular weight polymers have number average molecular weights of about 5,000 to about 100,000.

13. A method comprising,
a. mixing in a first step:
i. a first polymer,
ii. a filler,
iii. a first low molecular weight polymer comprising a block A and a block B, and
iv. a second low molecular weight polymer comprising one or more functional groups,
b. mixing in a second step:
i. the mixture obtained in step (a),
ii. a second polymer different from said first polymer, and
iii. optionally, additional filler,
wherein said block A comprises a majority of the same type of mer units that make up a majority of said first polymer and said block B comprises a majority of the same type of mer units that make up a majority of said second polymer, and wherein said first and second low molecular weight polymers have number average molecular weights of about 5,000 to about 100,000.

14. The method of claim 13, wherein said first polymer is polyisoprene.

15. The method of claim 13, wherein said second polymer is selected from the group consisting of styrene-butadiene rubber, styrene-isoprene rubber, styrene-isoprene-butadiene rubber, isoprene-butadiene rubber, polybutadiene, acrylonitrile-butadiene rubber, silicone rubber, fluoroelastomers, ethylene acrylic rubber, nitrile rubber, hydrogenated nitrile rubber, ethylene propylene rubber, ethylene propylene diene monomer rubber, butyl rubber, polychloroprene, and mixtures thereof.

16. The method of claim 13, wherein said second polymer is polybutadiene.

17. The method of claim 13, wherein said filler comprises carbon black.

18. The method of claim 16, wherein block A of said first low molecular weight polymer comprises polyisoprene and block B comprises polybutadiene.

19. The method of claim 13, wherein said second low molecular weight polymer is polyisoprene.

20. The method of claim 19, wherein said functional group(s) is selected from the group consisting of hydroxyl, carboxyl, carbonyl, alkoxy, alkoxycarbonyl, cyano, amino, amido, imido, mercapto, carbamoyl, azido, ester, ether, urethane, peroxide, imidazolyl, and pyridine groups, as well as derivatives of those groups, and mixtures thereof.

21. The method of claim 19, wherein said functional group(s) comprises carboxyl.

22. A method comprising,
a. mixing in a first step:
i. a first polymer comprising isoprene mer units,
ii. a filler,
iii. a first low molecular weight polymer comprising a block A and a block B, and
iv. a second low molecular weight polymer comprising isoprene mer units and one or more functional groups,
b. mixing in a second step:
i. the mixture obtained in step (a),
ii. a second polymer different from said first polymer, and
iii. optionally, additional filler,
wherein said block A comprises isoprene mer units and said block B comprises a majority of the same type of mer units that make up a majority of said second polymer, and wherein said first and second low molecular weight polymers have number average molecular weights of about 5,000 to about 100,000.
